(19) United States
(12) Patent Application Publication
(10) Pub. No.: US 2026/0153633 A1
(43) Pub. Date: Jun. 4, 2026

(54) Spoof-Resistant Wireless Navigation System

(71) Applicant: Viavi Solutions, Inc., Chandler, AZ (US)

(72) Inventor: Gregor Said Jackson, Las Vegas, NV (US)

(21) Appl. No.: 18/966,749

(22) Filed: Dec. 3, 2024

(51) Int. Cl. G01S 19/21; G01S 19/40; H04W 12/104

(52) U.S. Cl. CPC G01S 19/215; G01S 19/40; H04W 12/104

(57) ABSTRACT

Disclosed is a method in a wireless navigation system for correcting an accumulated error due to a spoofing event and related system. Average values of phase and frequency of a local oscillator during a normal operation of the wireless navigation system are measured and stored in a memory. A spoofer detection module detects a spoofing event. Upon detection of the spoofing event, the wireless navigation system stops the normal operation and calculates an accrued error in the phase and frequency of the local oscillator. The system then applies a correction to offset the accrued error and resumes normal operation.

### BACKGROUND

Modern wireless navigation systems rely on precise synchronization of time on local devices with standard times that are used as basis for wireless communications, such as communications by satellites or cell towers, and for precise navigation. For example, GPS (Global Positioning System) satellites need to be precisely synchronized with GPS receivers on earth, where both GPS satellites and GPS receivers are to maintain accuracy to nanoseconds with a global clock, which in the United States would be the UTC NIST (Coordinated Universal Time National Institute of Standards and Technology) in Colorado or the US Naval Office (USNO) in Maryland, utilized as reference signals in GPS navigation.

In one approach for maintaining precise synchronization between GPS satellites and a GPS receiver, the GPS receiver includes an electronic frequency control (EFC) to keep the local oscillator in phase with the phase of a GPS reference signal, which is itself in phase with, for example, a UTC clock. The EFC allows the GPS receiver to steer the frequency of the local oscillator up or down by a few parts per trillion (ppt) to keep its phase within 5 nanoseconds to 10 nanoseconds of the UTC clock as transmitted by the GPS satellites. As such, the GPS receiver's local oscillator is precisely phase locked with the GPS reference signal.

However, the GPS receivers are often under attack by spoofers. The spoofing signals result in injection of phase and frequency error in the local oscillator of the GPS receiver, which in turn cause errors in determining the position and velocity of the GPS receiver. Even in stationary applications, imposing phase and frequency errors on the local oscillator can result in significant harm. For example, dams, power generators and cell towers all rely on accurate phase and frequency synchronization with GPS satellites.

Thus, there is need in the art for removing the frequency, phase, position and velocity errors that a spoofer can cause in navigation systems.

### SUMMARY

The present disclosure is directed to a spoof-resistant wireless navigation system, substantially as shown in and/or described in connection with at least one of the figures, and as set forth in the claims.

### BRIEF DESCRIPTION OF THE DRAWINGS

FIG. 1 is a block diagram of a spoof-resistant wireless navigation system according to one implementation of the present application.

FIG. 2 is a diagram illustrating accumulation of phase and frequency error due to a spoofing event and correction of the accumulated error according to one implementation of the present application.

FIG. 3 is a flow chart illustrating operation of one implementation of the present application.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

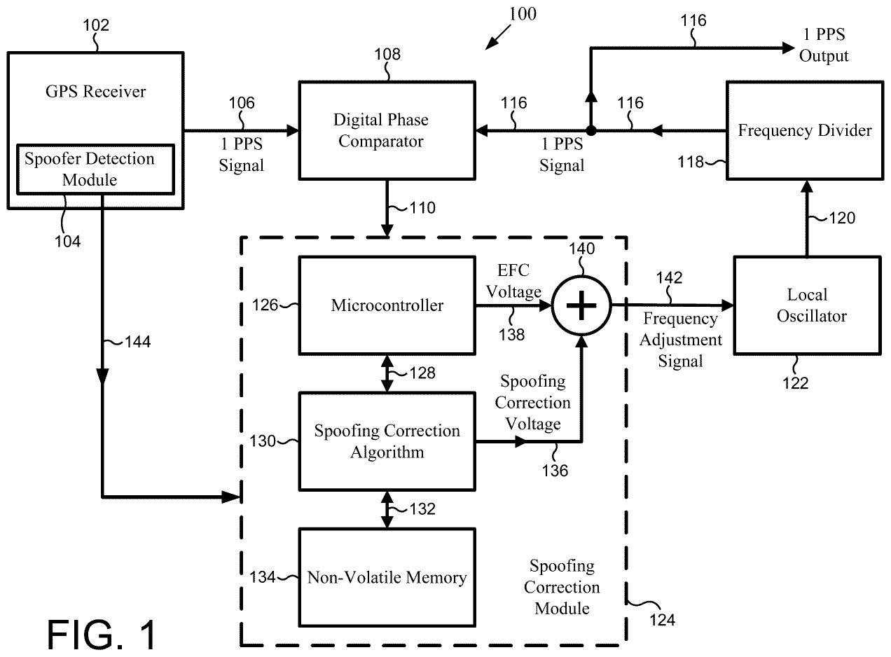

FIG. 1 shows spoof-resistant wireless navigation system 100. Wireless navigation system 100 comprises GNSS (Global Navigation Satellite System) receiver 102. To preserve brevity, and by way of a specific example, satellite receiver 102 is often referred to as GPS (Global Positioning System) receiver 102 in the present implementation. However, GPS receiver 102 may be replaced by any other GNSS (Global Navigation Satellite System) receiver such as a Galileo receiver or GLONASS receiver without departing from the inventive concepts of the present application. Instead of GNSS, other RF-based systems such as eLORAN (Enhanced Long-Range Navigation), LEO (Low Earth Orbit) satellite, and GEO (Geostationary Earth Orbit) satellites can also be used in various implementations of the present application, and the inventive concepts described herein apply equally to these RF-based systems.

According to one implementation of the present application, spoofer detection module 104 is incorporated into GPS receiver 102. GPS receiver output 106 is a Pulse Per Second (1 PPS) GPS signal that is provided to digital phase comparator 108. Digital phase comparator 108 compares 1 PPS signal 116 provided by frequency divider 118 with 1 PPS signal 106 and provides digital comparator output 110 to spoofing correction module 124.

In the present implementation, spoofing correction module 124 comprises microcontroller 126 which runs and/or is in communication with spoofing correction algorithm 130. Microcontroller 126 and spoofing correction algorithm 130 interface and store and retrieve data from non-volatile memory 134. In one implementation, memory 134 is a random access memory (RAM) that is not a non-volatile memory. Spoofing correction module 124 further includes adder 140 which receives an EFC (Electronic Frequency Control) voltage 138 determined by microcontroller 126 and spoofing correction voltage 136 determined by spoofing correction algorithm 130 and outputs the sum of the two voltages as frequency adjustment signal 142.

Local oscillator 122 receives frequency adjustment signal 142 and provides local oscillator output 120 to frequency divider 118. Frequency divider 118 divides the frequency of local oscillator output 120 by a predetermined factor to generate 1 PPS output signal 116 which is inputted to digital phase comparator 108 and also provided as 1 PPS output of spoof-resistant navigation system 100.

In operation, spoof-resistant navigation system 100 can also be utilized to correct position and velocity errors that are imposed on navigation system 100 due to spoofing signals that would otherwise adversely impact phase and frequency of local oscillator output 120 which in turn forms the basis for what is intended to be an extremely accurate 1 PPS output signal 116. Spoofer detection module 104 within GPS receiver 102 can detect presence of a spoofer by various methods, such as receiving a message from a secondary channel. For example, secondary channels, such as those available through the Internet or various satellite signals can be utilized for a satellite navigation message authentication (NMA) received by GPS receiver 102. GPS receiver 102 can also receive the NMA authentication message over a network such as Networked Transport of RTCM via Internet Protocol (NTRIP) or another similar network-distributed authentication data protocol.

As another example, a spoofer can be detected when adjacent cell towers report spoofing through a national real-time spoofing event registrar. Alternatively, data from a local Inertial Measurement Unit (IMU) or the frequency of oscillation of local oscillator 122, which is an extremely stable oscillator, can be utilized to detect presence of a spoofer.

For example, if local oscillator 122 only had errors of +/−2 parts per trillion (ppt) to keep it in phase with UTC (Coordinated Universal Time) or with GPS time, and there is suddenly a frequency change of hundreds of ppt or there is a phase error of hundreds of nanoseconds, or if the IMU indicates that wireless navigation system 100 is stationary, when according to GPS receiver 102 system 100 is moving in a certain direction at a speed of, for example, five miles per hour, then spoofer detection module 104 may determine that system 100 is under a spoofing attack due to the detected difference in the velocity. As a result, spoofer detection module 104 provides output 144 to alert spoofing correction module 124 to execute spoofing correction algorithm 130 in order to generate an appropriate frequency adjustment signal 142 for applying a correction to offset the spoofing error imposed on spoof-resistant navigation system 100 in the manner discussed below.

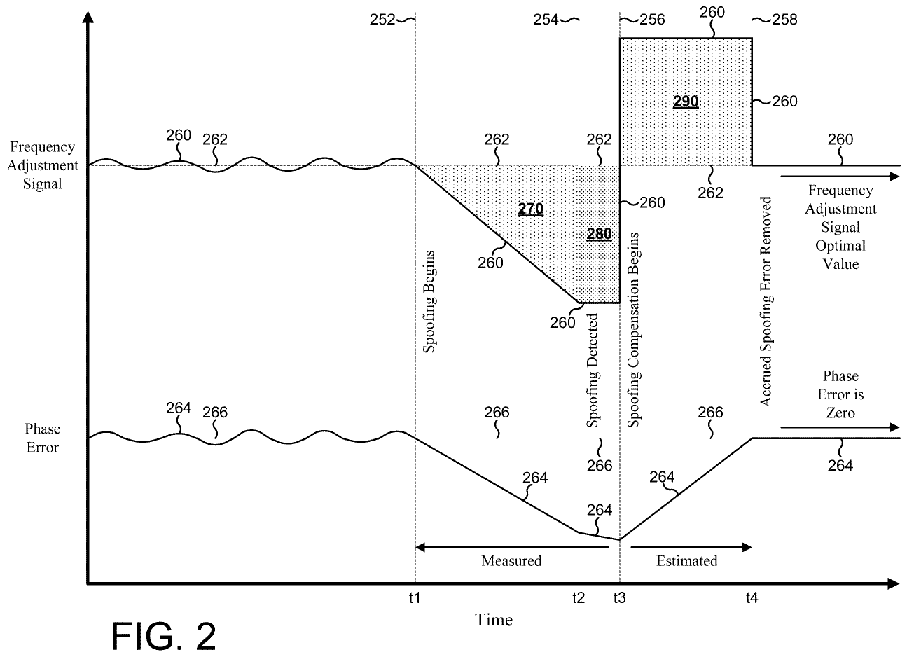

FIG. 2 is an example illustrating how interference by a spoofer on GPS receiver 102 results in a phase error induced in local oscillator 122. FIG. 2 illustrates how the spoofer-caused phase error is corrected by adjustments made to frequency adjustment signal 142. The correction of the phase error is a result of correcting the frequency of local oscillator 122 in response to adjustments made to frequency adjustment signal 142. The interference by the spoofer also results in erroneous readings of position and velocity by GPS receiver 102. The accompanying position and velocity errors and corrections made thereto are not shown in FIG. 2. However, due to the correction made to frequency adjustment signal 142, a concomitant correction to position and velocity by spoof-resistant navigation system 100 is also achieved.

The operation of spoof-resistant wireless navigation system 100 is now explained in more detail by reference to FIGS. 1 and 2. During normal operation of wireless navigation system 100, i.e. prior to detection of a spoofing event by spoofer detection module 104, GPS receiver 102 receives GPS reference signals as usual and outputs 1 PPS signal 106 to digital phase comparator 108. Output 144 of spoofer detection module 104 does not alert or suspend normal operation of spoofing detection module 124. During its normal operation, spoofing detection module 124 receives output 110 of digital phase comparator 108 which is a result of comparing 1 PPS signal 106 outputted by GPS receiver 102 with 1 PPS signal 116 outputted by frequency divider 118.

During normal operation, output 110 of digital phase comparator 108 indicates only very minor differences between 1 PPS signal 106 and 1 PPS signal 116; for example, differences in the range of two to four parts per trillion (ppt). Microcontroller 126, that executes spoofing correction algorithm 130 and is in communication with non-volatile memory 134, outputs a steady state EFC voltage 138 since spoofing correction algorithm 130 has not been activated. Thus, average of values of steady state oscillation frequencies stored in non-volatile memory 134 are used as the basis for microcontroller 126 to generate a steady state EFC voltage 138 that is substantially constant over time when no spoofing event has been detected. During normal operation, spoofing correction voltage 136 has a constant nominal value, such as zero, so that output of adder 140 is unaffected by spoofing correction voltage 136 and is determined substantially by EFC voltage 138.

Output of adder 140 is frequency adjustment signal 142 that controls the oscillation frequency of local oscillator 122. During normal operation, local oscillator 122 provides an output 120 with a steady state oscillation frequency to frequency divider 118. For example, output 120 of local oscillator 122 can have a frequency of 10 MHz. Frequency divider 118 divides the frequency provided at output 120 of local oscillator 122 by an appropriate amount to provide 1 PPS signal 116. In the above example, frequency divider 118 divides the frequency by a factor of 10 million, to generate 1 PPS signal 116. In normal operation, 1 PPS signal 116 is substantially in sync with 1 PPS signal 106 from GPS receiver 102, and frequency adjustment signal 142 makes only very minor adjustments to oscillation frequency of local oscillator 122.

Dashed line 262 corresponds to the average value of frequency adjustment signal 142 that is provided to local oscillator 122 to adjust its frequency. Average value 262 is achieved by averaging over for example, 72 hours, 48 hours, 24 hours, or 12 hours of actual voltage values of frequency adjustment signal 142 in spoof-resistant wireless navigation system 100 of FIG. 1.

During normal operation, that is prior to time t1, local oscillator 122 is locked in phase to a reference signal coming over the air. As noted above, in the present example, the reference signal is a GPS signal received by GPS receiver 102. Normal operation continues until time t1, when a spoofer takes GPS receiver 102. Normal operation voltage values of frequency adjustment signal 142 is shown by line 260 in FIG. 2. As shown, actual voltage values 260 slightly fluctuate around average voltage value 262. Prior to the point when a spoofer interferes with the operation of spoof-resistant navigation system 100, that is prior to time t1 indicated by dashed line 252, typical variations of actual voltage values 260 around the baseline, that is around average voltage value 262, are very small, and result in, for example, a change of about two to four parts per trillion (ppt) in the local oscillator's frequency. As an example, a four ppt change in oscillation frequency of 10 MHz, that is a change of 0.00004 Hz, can be achieved with only 10 microvolts (since a typical oscillator undergoes a frequency change of 4 Hz per volt). It is noted that in some implementations using more recent oscillators, such as MEMS oscillators, the oscillator frequency can be digitally controlled, instead of analog control by the EFC voltage. Digital control is as effective as analog EFC control.

At time t1, prior to the time that a spoofing event has been detected, the spoofer will try to pull wireless navigation system 100 off the GPS reference signal frequency. When spoofing begins, that is at time t1 indicated by dashed line 252, actual voltage value 260 of frequency adjustment signal 142 begins to significantly change at a pace significantly different from the small fluctuations before time t1. For example, actual voltage value 260 can increase or decrease by hundreds ppt, instead of the steady state of two to four ppt. When the sudden and significant change in actual voltage value 260 of frequency adjustment signal 142 reaches a predesignated threshold value of change, for example, 100 ppt, spoofer detection module output 144 alerts and activates spoofing correction module 124 since a spoofing event has been detected.

In the example of FIG. 2, the spoofing event is detected at time t2 indicated by dashed line 254. When the spoofing event is detected, actual voltage value 260 of frequency adjustment signal 142 has passed a predesignated threshold value that is significant enough to indicate that a spoofing event has occurred. For example, it is seen in FIG. 2 that at time t2 actual voltage value 260 is significantly below average value 262. Thus, at time t2, spoofing detection module 104 has detected a spoofing event in spoof-resistant wireless navigation system 100.

Once a spoofing event has been detected, that is when spoofer detection module 104 activates spoofing correction module 124 of a spoofing event, microcontroller 126 executes spoofing correction algorithm 130. When spoofing correction algorithm 130 is executed, the value of frequency adjustment signal 142 is frozen in place and is no longer responsive to the frequency of the spoofing signal. As shown in FIG. 2, at time t2 indicated by dashed line 254, the spoofing event has been detected, and frequency adjustment signal voltage value 260 stops changing.

FIG. 2 shows the phase error line 264 of local oscillator 122 that, prior to time t1 (i.e. prior to the time that a spoofing signal is received), fluctuates by a very minor amount (for example, two to ten nanoseconds) around zero phase error line 266 (i.e. the steady state or average phase error). From time t1 to time t2, that is from when a spoofing signal is received by GPS receiver 102 to the time that spoofing detection module 104, the phase error of local oscillator 122 increases as shown in FIG. 2. That is, since the frequency of local oscillator is being locked onto the spoofing signal frequency, the phase error continues to increase between time t1 and time t2. In general, the amount of phase error is provided by the following equation:

Phase error in seconds=(spoofed reference frequency error ppt*number of seconds of spoofing)/2

For example, if the spoofing signal introduces an error in the local oscillator frequency of 1000 ppt for 60 seconds, then the total accrued phase error would be 30000 e-12 or 30 nanoseconds.

The shaded area 270 between time t1 (line 252) and time t2 (line 254) and between average value 262 of frequency adjustment signal 142 and actual value 260 of frequency adjustment signal 142 illustrates accumulation of error in local oscillator 122 prior to detection of a spoofing event by spoofer detection module 104. The time interval between time t1 and time t2 can be, for example, a few seconds and up to two minutes or more. The difference between actual voltage values 260 of frequency adjustment signal 142 between at time t1 compare to time t2 can be 100 or more ppt. The accumulated phase error 264 between time t1 and time t2 can be, for example, hundreds of nanoseconds.

As noted above, when spoofing correction algorithm 130 is executed, spoof-resistant navigation system 100 goes “offline” and the value of frequency adjustment signal 142 is frozen in place and would be no longer responsive to the frequency of the spoofing signal, and frequency adjustment signal voltage value 260 stops changing. From time t2 (indicated by line 254) to time t3 (indicated by line 256), spoofing correction module 124 in spoof-resistant navigation system 100, and more particularly, microcontroller 126 executing spoofing correction algorithm 130 calculates the total synthetically added error that the spoofer was able to push onto local oscillator 122, which is the total error that need be undone by spoof-resistant navigation system 100.

Since between time t2 and time t3, voltage output of frequency adjustment signal 142 was frozen, error in frequency of local oscillator 122 still persists and is being accumulated. This error is shown as region 280 in FIG. 2. Furthermore, phase error is also being accumulated between time t2 and time t3, as shown by phase error line 264. The reason is that local oscillator 122 continues to run at an incorrect frequency (i.e. off frequency of the reference GPS signal), since the effect of the spoofing signal on frequency adjustment signal 142 and its actual voltage value as shown by line 260 has not yet been reversed in the interval between time t2 and time t3. However, since any further change to frequency of local oscillator 122 is stopped at time t2, phase error line 264 shows a reduced rate of change between times t2 and t3 relative to the rate of change between times t1 and t2.

At time t3, spoofing correction algorithm 130 has determined the amount of accrued error imposed on local oscillator 122 by reference to average values of frequency of local oscillator 122 and average voltages of frequency adjustment signal 142 stored in non-volatile memory 134. As such, at time t3, spoofing correction algorithm 130 applies the calculated spoofing correction voltage 136 for addition to EFC voltage 138 by adder 140. At time t3, adder 140 outputs a corrected frequency adjustment signal 142 to local oscillator 122 for a predetermined amount of time, i.e. up to time t4 indicated by line 258.

Thus, between time t3 and time t4, the total error, that is the sum of the errors shown as regions 270 and 280 in FIG. 2 is reversed by application of a corrected frequency adjustment signal having a corrected voltage value 260 in region 290, that is in the region between time t3 and time t4. In one implementation of the present invention, the total area under regions 270 and 280 is substantially the same as the total area under region 290.

As seen in FIG. 2, the interval between time t2 (line 254) and time t3 (line 256) corresponds to the time after spoofing has been detected up to the point at which spoofing correction module 124 has calculated what corrective action needs to be taken to cancel out the effect of the spoofing signal on the phase and frequency of local oscillator 122. In one implementation, the interval between time t2 and time t3 is much smaller than the interval between time t1 and time t2. While the interval between time t1 and time t2 can be few seconds to a few minutes, the interval between time t2 and time t3 can be one millisecond up to two seconds.

The interval between time t2 and time t3 is utilized by microcontroller 126 and spoofing correction algorithm 130 to perform calculations necessary to offset the effect of spoofing signal on the value of frequency adjustment signal 142 that controls local oscillator 122. At time t3, spoofing correction algorithm 130 has determined how far off the phase and frequency of local oscillator 122 are relative to their historic average values shown by line 262. For example, spoofing correction algorithm may determine that at time t3 the frequency of local oscillator 122 is off by 100 ppt and the phase of local oscillator 122 is off by hundreds of nanoseconds.

It is noted that after time t3 (line 256), system 100 applies a correction to counter the accumulated error imposed on oscillation phase and frequency, shown graphically in regions 270 and 280 of FIG. 2. The applied correction is shown graphically as region 290 in FIG. 2. As discussed above, it has been mathematically determined at time t3 that the spoofer has been able to spoof GPS receiver 102 for a certain amount of time, i.e. from time t1 to time t3. As shown graphically in region 290, to reverse the effect of spoofing on the phase and frequency error, a correction need be applied over a certain amount of time that is proportional to the amount of time during which spoofing was taking place to cause frequency error (between time t1 and time t2), or to cause phase error (between time t1 and time t3).

In region 290, that is between time t3 and time t4, wireless navigation system 100 adjusts the local oscillator frequency in the opposite direction that the spoofer was able to pull system 100 into. At time t4, the phase error goes back to zero or near zero as shown by phase error line 264 in FIG. 2. Spoofing correction algorithm 130 stops compensating for the spoofing error as soon as local oscillator frequency 122 is substantially the same as its average over, for example, the last 2, 12, or 24 hours, which is shown graphically as line 262 in FIG. 2. When frequency of local oscillator 122 is restored to its average at time t4, the phase error as shown by line 264 is reduced to zero or near zero.

When system 100 determines that the frequency error has been corrected sufficiently to bring the frequency to its historic average value, i.e. at time t4, spoofing correction algorithm 130 stops correcting, that is spoofing correction voltage 136 is reduced to zero, and the frequency adjustment signal 142 is restored to its optimal value as shown by line 260 after time t4. The optimal value of frequency adjustment signal 142 is, for example, substantially the same as its value mathematically averaged over the last 2, 12, or 24 hours stored in non-volatile memory 134. In one implementation, a typical interval between time t3 (i.e. when the spoofing correction begins) to time t4 (i.e. when accrued spoofing error has been removed) is, for example, approximately two to four minutes.

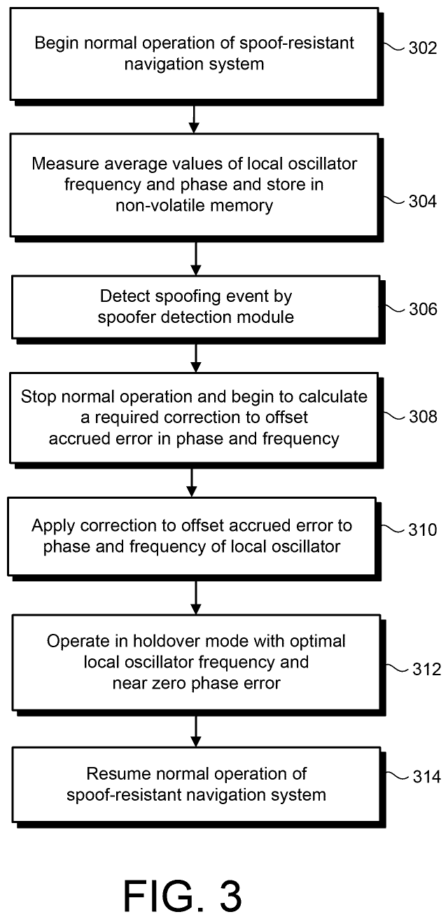

The operation of spoof-resistant wireless navigation system 100 is now discussed by reference to the flow chart 300 of FIG. 3. Spoof-resistant wireless navigation system 100 begins and continues in a normal operation mode (action 302). During normal operation, average values of the phase and frequency of local oscillator 122 are measured and stored in non-volatile memory 134 (action 304). Normal operation continues until a spoofing event is detected by spoofer detection module 104 (action 306).

It typically takes wireless navigation system 100 about a few seconds to a few minutes to detect a spoofing event after the initial spoofing signals are received. For examples, system 100 receives a first signal from a GPS satellite, which is either a true GPS signal or a spoofed signal. System 100 does not initially recognize whether it is being spoofed or true a GPS signal is being received, but the system initially presumes the signal to be a true GPS signal. In one implementation, a second signal from a different satellite at a different frequency provides a checksums of the GPS signal. That signal can be, for example, a navigation message authentication (NMA) which GPS receiver 102 receives either through a satellite or the Internet or another communication source that provides a checksum to system 100 that indicates whether a real GPS signal has been received. If the checksum is not a match, thus indicating that a real GPS signal has not been received, then a spoofed signal has been received. In one implementation, the algorithm that transmits the checksum data, does not transmit the data in real time, it transmits the checksum data, for example every 10 to 20 seconds. Further, there are processing and verification delays. Thus, anywhere between a few seconds to a few minutes may pass before spoofing is detected by spoofing detection module 104 of system 100.

In another implementation, even if an NMA or checksum are not provided to system 100, system 100 may utilize other methods to detect a spoofing event. When system 100 has determined that, for example, during the last three to five days, frequency variations of local oscillator 122 is within a very small range, for example, +/−2 ppt, and suddenly there is a large change in frequency, spoofer detection module 104 determines that a spoofing event has occurred.

Depending on the stability of local oscillator 122, the last 72 hours of statistical data stored in non-volatile memory 134. This may be the case for a rubidium oscillator that is very stable. Rubidium oscillators are typically stable to about two to three ppt. Thus, a sudden change of 50 ppt in frequency of a rubidium oscillator indicates the presence of a spoofer. For an oscillator that is less stable or less expensive than a rubidium oscillator, only the last 2 hours may be used since the oscillator may be reacting to ambient temperature, for example day to night temperature, or factors other than spoofing, so a smaller range of statistical data, for example 2 hours of data as opposed to 72 hours of data, may be more reliable as a basis for comparison to determine presence of a spoofing event.

After detecting a spoofing event (action 306), wireless navigation system 100 stops normal operation and begins to calculate an accrued error in the frequency of local oscillator 122 (action 308). Then, a required correction to offset the accrued error in frequency is calculated based on the accrued error (action 308). As illustrated in relation to FIGS. 1 and 2, spoofing correction algorithm 130 determines the integral of the deviation of the spoofed oscillator frequency relative to the average oscillator frequency over time. The spoofed oscillation frequency deviating from the stored average oscillation frequency, i.e. the steady state baseline, is artificial and is integrated over time to determine an accumulated error.

The present implementation continues with action 310 by applying a correction to offset the accrued error in frequency of local oscillator 122. The correction is applied when spoofing correction algorithm 130 determines an appropriate spoofing correction voltage 136 which results in correcting frequency adjustment signal 142 to offset the accrued error in frequency caused by a spoofer. Offsetting the accrued error in the frequency in turn results in offsetting the phase error caused by the spoofer.

Once the accrued error has been removed, and as long as spoofing is continuing after time t4, wireless navigation system 100 runs in a “holdover” mode by holding the optimal value of frequency adjustment signal 142, resulting in an optimal frequency that is approximately the same as the stored average frequency, and a zero or near zero phase error for local oscillator 122 (action 312). In the holdover mode, local oscillator 122 is used as frequency and phase reference in system 100.

When spoofing detection module 104 determines that spoofing has been discontinued, system 100 resumes normal operation (action 314). In the normal operation mode, the reference signal of GPS receiver 102 is utilized to perform minor corrections to the frequency of local oscillator 122 by utilizing the phase-locked loop algorithm operating prior to time t1 in FIG. 2.

In addition to detecting and compensating for errant behavior of a GNSS receiver due to spoofing, various implementations of the present application can compensate for software glitches in the GNSS receiver, jamming, or failure of the local oscillator itself. In general, the present inventive concepts can also be employed to execute a spoofing correction algorithm to correct a phase and frequency error due to hardware failure in the wireless navigation system (such as in the GNSS receiver), in the IMU, in the local oscillator of the wireless navigation system, or in the secondary authentication channel that provides a synchronization message to the wireless navigation system (which could itself also be spoofed). Since the effect of all these failure modes is a sudden and significant change in the frequency of the local oscillator, the inventive concepts described in the present application apply equally to correct for accrued frequency and phase error in these failure modes.

Furthermore, the present inventive concepts can be utilized to detect and correct for position errors due to spoofing. For example, if the wireless navigation system detects that its position is spoofed by comparing its position to the IMU (the IMU can measure acceleration and thus calculate heading and velocity), the system determines the length of time in which the position spoofing was taking place and measure the time, direction, and velocity errors that the spoofer was able to impose onto the wireless navigation system. The spoofing correction algorithm can then “back out” of the position error by applying an opposite velocity and direction to the latest position.

For example if, due to the error imposed by the spoofer, the wireless navigation system had determined that it was moving at 5.0 miles per hour towards east for 6.0 minutes, then the accrued position error is 0.5 miles to the east of the true position of the wireless navigation system. Thus, the wireless navigation system applies a synthetic position correction of, for example, a velocity of 10.0 miles per hour for 3.0 minutes towards west. The wireless navigation system would then reach the true position after 3.0 minutes—the position the wireless navigation system would have been at absent the spoofing event. As such, the wireless navigation system is able to “back out” of the spoofed position.

The present application has disclosed various exemplary implementations of a spoof-resistant navigation system. Moreover, as understood by a person of ordinary skill in the art that the present inventive concepts result in correction of position and velocity as determined by system 100 and GPS receiver 102, as a consequence of and in addition to removal of the accumulated error in phase and frequency of local oscillator 122. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A method in a wireless navigation system, said method comprising:
measuring and storing average values of phase and frequency of a local oscillator during a normal operation of said wireless navigation system;
detecting a spoofing event in said wireless navigation system;
stopping said normal operation and calculating an accrued error in said phase and frequency of said local oscillator;
applying a correction to offset said accrued error;
resuming said normal operation of said wireless navigation system.

2. The method of claim 1, wherein said wireless navigation system is a GNSS (Global Navigation Satellite System) receiver comprising one of a GPS receiver, a Galileo receiver, and a GLONASS receiver.

3. The method of claim 1, wherein said wireless navigation system is a GPS receiver.

4. The method of claim 1, wherein said detecting said spoofing event comprises detecting a substantial change in said phase and frequency of said local oscillator.

5. The method of claim 1, wherein said detecting said spoofing event comprises receiving a message from a secondary channel.

6. The method of claim 5, wherein said message is received from one of a satellite providing a navigation message authentication (NMA), a cell tower adjacent to said wireless navigation system, and an inertial measurement unit (IMU) of said wireless navigation system.

7. The method of claim 1, wherein said resuming said normal operation of said wireless navigation system comprises restoring said phase and frequency of said local oscillator to approximately said average values.

8. The method of claim 1, wherein said wireless navigation system executes a spoofing correction algorithm to determine said accrued error by calculating an integral of deviation of a spoofed phase and frequency of said local oscillator relative to said average values over time.

9. The method of claim 1, further comprising executing a spoofing correction algorithm to correct a phase and frequency error due to hardware failure in said wireless navigation system, in an IMU, in a local oscillator of said wireless navigation system, or in a secondary authentication channel that provides a synchronization message to said wireless navigation system.

10. A wireless navigation system comprising:
a GNSS (Global Navigation Satellite System) receiver including a spoofer detection module;
a local oscillator;
a spoofing correction module, including a microcontroller and a memory, said memory having stored therein average values of phase and frequency of said local oscillator during a normal operation of said wireless navigation system;
said spoofing correction module determining an accrued error in said phase and frequency of said local oscillator and generating a frequency adjustment signal to apply a correction to offset said accrued error.

11. The wireless navigation system of claim 10, wherein said wireless navigation system is a GNSS receiver comprises one of a GPS receiver, a Galileo receiver, and a GLONASS receiver.

12. The wireless navigation system of claim 10, wherein said spoofer detection module detects a spoofing event by detecting a substantial change in said phase and frequency of said local oscillator.

13. The wireless navigation system of claim 10, wherein said spoofer detection module is configured to receive a message from a secondary channel alerting said spoofing detection module of a spoofing event.

14. The wireless navigation system of claim 13, wherein said message is a navigation message authentication (NMA) message received from a satellite or received as a network-distributed authentication data protocol, or received from a cell tower adjacent to said wireless navigation system, or received from an inertial measurement unit (IMU) of said wireless navigation system.

15. The wireless navigation system of claim 10, wherein said wireless navigation system resumes said normal operation by restoring said phase and frequency of said local oscillator to approximately said average values after detecting a spoofing event.

16. The wireless navigation system of claim 10, wherein said spoofing correction module determines said accrued error by calculating an integral of deviation of a spoofed phase and frequency of said local oscillator relative to said average values over time.

17. A GPS receiver comprising:
a spoofer detection module;
a local oscillator;
a spoofing correction module, including a microcontroller and a memory, said memory having stored therein average values of phase and frequency of said local oscillator during a normal operation of said GPS receiver;
said spoofing correction module determining an accrued error by calculating an integral of deviation of a spoofed phase and frequency of said local oscillator relative to said average values over time;
said spoofing correction module generating a frequency adjustment signal to apply a correction to offset said accrued error.

18. The GPS receiver of claim 17, wherein said spoofer detection module detects a spoofing event by detecting a substantial change in said phase and frequency of said local oscillator.

19. The GPS receiver of claim 17, wherein said spoofer detection module detects a spoofing event by receiving a message from a secondary channel.

20. The GPS receiver of claim 19, wherein said message is received from a satellite providing a navigation message authentication (NMA), a cell tower adjacent to said GPS receiver, or an inertial measurement unit (IMU) of said GPS receiver.

21. The GPS receiver of claim 17, wherein upon detecting a spoofing event said spoofer detection module activates said spoofing correction module to execute a spoofing correction algorithm to generate said frequency adjustment signal.
